(19) United States
(12) Patent Application Publication
(10) Pub. No.: US 2026/0352487 A1
(43) Pub. Date: Nov. 5, 2026

(54) SYSTEMS AND METHODS FOR ON-CHAIN/OFF-CHAIN INTERACTIONS

(71) Applicant: Mysten Labs, Inc., Palo Alto, CA (US)

(72) Inventors: I-Sheng CHEN, Palo Alto, CA (US); Konstantinos CHALKIAS, Dubai (AE); Arnab ROY, Palo Alto, CA (US); George DIGKAS, Palo Alto, CA (US); John NAULTY, Palo Alto, CA (US); Dionysios LOUGARIS, Palo Alto, CA (US)

(21) Appl. No.: 19/664,518

(22) Filed: Apr. 30, 2026

Related U.S. Application Data
(60) Provisional application No. 63/797,581, filed on Apr. 30, 2025.

(51) Int. Cl. H04L 9/32; H04L 9/00; H04L 9/08; H04L 9/30

(52) U.S. Cl. CPC H04L 9/3247; H04L 9/0825; H04L 9/30; H04L 9/3218; H04L 9/50

(57) ABSTRACT

The present technology includes systems and methods for low-latency, stateful interactions between two parties in a blockchain environment by shifting execution of application logic off-chain while preserving security and verifiability. An off-chain communication channel is established in association with an on-chain smart contract, allowing the parties to exchange a sequence of cryptographically authenticated state updates that collectively represent a current interaction state. A respective update is validated through coordinated cryptographic operations between the parties, forming a verifiable chain of state transitions. The disclosed approach reduces on-chain transaction overhead while maintaining trust, enabling applications such as interactive gaming, streaming services, and incremental payment systems.

### CROSS-REFERENCE TO RELATED APPLICATIONS

This Application claims priority to U.S. Provisional Application 63/797,581 filed on Apr. 30, 2025, and titled “PROGRAMMABLE P2P TUNNELS,” the entire contents of which is incorporated herein by reference.

### BACKGROUND

Distributed ledger technologies, such as blockchain platforms, enable the execution of transactions and application logic in a decentralized and tamper-resistant manner. In some cases, interactions between participants are recorded on-chain through transactions that are validated and permanently stored by the network. Such approaches are commonly used in applications including digital asset transfers, gaming, and service delivery systems.

In certain use cases, applications may involve a sequence of interactions between two or more parties, where the state of the interaction evolves over time based on inputs from the participants. For example, interactive applications such as games, streaming services, and incremental payment arrangements may involve frequent state changes that reflect ongoing activity between the parties.

Various techniques have been developed to facilitate interactions associated with blockchain systems, including the use of off-chain mechanisms in which certain operations are performed outside of the blockchain while maintaining a relationship with on-chain data. These approaches may utilize cryptographic techniques to authenticate data exchanged between parties and to enable subsequent verification.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example operating system for implementing the present technology.

FIG. 2A illustrates an example on-chain interaction between two devices.

FIG. 2B illustrates an example hybrid on-/off-chain interaction between two devices in accordance with some aspects of the present disclosure.

FIG. 3A and 3B illustrate steps in an example scenario in which a hybrid on-/off-chain interaction occurs between two devices in accordance with some aspects of the present disclosure.

FIG. 4 illustrates an example method for failure handling in accordance with some aspects of the present disclosure.

FIG. 5 illustrates an example method for off-chain interaction between two devices via a tunnel in accordance with some aspects of the present disclosure.

FIG. 6 shows an example of a system for implementing certain aspects of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Blockchain-based systems enable secure and decentralized execution of transactions and application logic. In some cases, interactions between participants are performed through on-chain transactions that are validated and recorded by a distributed ledger. While such approaches provide strong guarantees of integrity and transparency, certain applications involve sequences of interactions that evolve over time and may require frequent updates to a shared state between participants.

In scenarios such as interactive gaming, streaming services, and incremental payment arrangements, participants may engage in a series of rapid, state-dependent actions. Performing each of these actions as a separate on-chain transaction can introduce latency and computational overhead, and may affect responsiveness in applications that benefit from near real-time interaction. Additionally, when interactions are conducted outside of the blockchain environment, mechanisms are needed to ensure that the participating parties adhere to agreed-upon rules and that outcomes remain verifiable.

The present technology provides techniques for facilitating stateful interactions between parties by using an off-chain communication channel, referred to herein as a tunnel, that operates in association with an on-chain smart contract. For example, two parties may establish the tunnel and initialize a shared state by locking corresponding assets on the blockchain. Thereafter, the parties exchange a sequence of state updates off-chain, where each state update represents an interaction and is cryptographically authenticated by both parties. The authenticated state updates are linked to form a verifiable chain representing the current state of the interaction.

In certain examples, one party validates state updates generated by the other party prior to providing a corresponding cryptographic signature, enabling enforcement of application-specific rules during off-chain execution. Additionally, cryptographic data generated during the interaction, such as digital signatures, may be used to derive verifiable randomness for subsequent state updates, thereby supporting applications that incorporate probabilistic behavior.

In the event of a failure condition, such as a lack of response or a disagreement between the parties, one or more state updates and associated cryptographic data may be submitted to the on-chain smart contract. The smart contract can then verify the submitted information and determine a final outcome, including allocation of locked assets, based on the most recent valid state. This mechanism allows the system to maintain integrity and enforceability even when off-chain interactions cannot be completed cooperatively.

Failure handling mechanisms are used to ensure reliable and enforceable operation of off-chain interactions in situations where one or more participants do not cooperate or where inconsistencies arise. For example, a participant may become unresponsive, refuse to provide a required cryptographic signature, or attempt to rely on an outdated state of the interaction. In such circumstances, failure handling enables escalation from off-chain processing to an on-chain smart contract, allowing submission and verification of previously agreed-upon state updates. Thus, the interaction can progress to a valid outcome and assets or results are allocated according to the most recent valid state, thereby maintaining correctness, preventing misuse, and ensuring completion of the interaction.

The present technology provides several technical advantages. By allowing a sequence of interactions to be executed off-chain while maintaining cryptographic verifiability, the present technology reduces reliance on on-chain transactions and improves responsiveness for interactive applications. The use of chained, authenticated state updates provides a mechanism for detecting inconsistencies and preserving an authoritative state history. The integration of on-chain fallback mechanisms ensures that outcomes can be enforced in the presence of faults or adversarial behavior. Additionally, deriving randomness from cryptographic operations within the interaction reduces dependence on external randomness sources while maintaining determinism and verifiability. Collectively, these features facilitate efficient, secure, and flexible execution of stateful interactions in blockchain-associated systems.

The above is a description of some of the advantages of the present technology. Additional features and advantages will be addressed in more detail herein.

As used herein, the term “user” shall be considered to mean a user of an electronic device(s). Actions performed by a user in the context of computer software shall be considered to be actions taken by a user to provide an input to the electronic device(s) to cause the electronic device to perform the steps embodied in computer software. In some instances a user can refer to a user account associated with a particular electronic device.

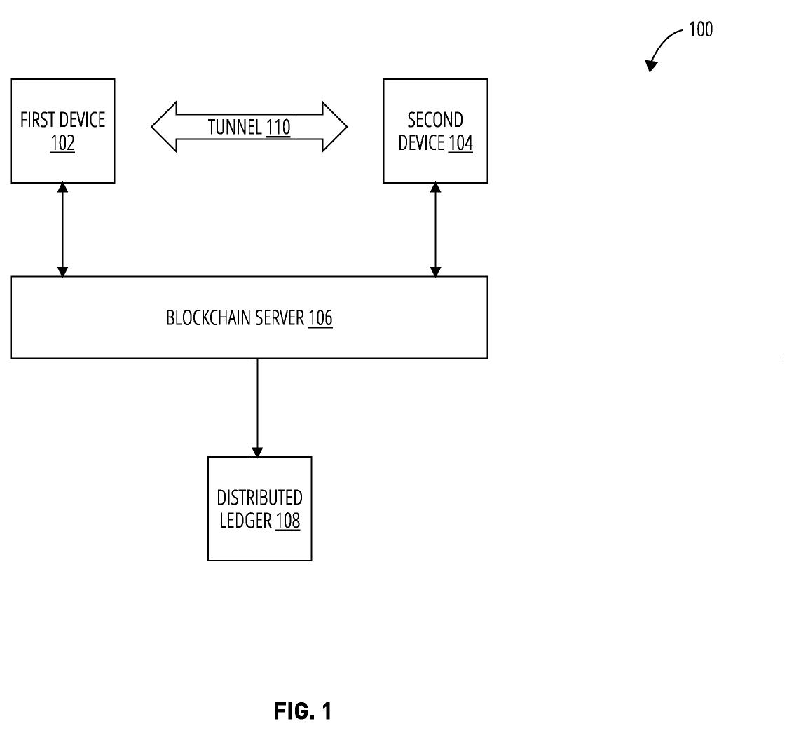

FIG. 1 illustrates an example operating environment 100 for facilitating off-chain interactions between a plurality of devices in association with a blockchain network. Operating environment 100 includes a first device 102, a second device 104, a blockchain server 106, and a distributed ledger 108. First device 102 and second device 104 may communicate with one another via an off-chain communication channel, referred to herein as tunnel 110.

First device 102 and second device 104 may correspond to computing devices operated by respective participants. For example, first device 102 and/or second device 104 may be a user device, client device, or other processing system capable of executing application logic and performing cryptographic operations. First device 102 and/or second device 104 may include one or more processors, memory, and communication interfaces configured to generate, transmit, receive, and verify data associated with state updates, as described herein.

Blockchain server 106 represents one or more nodes of a blockchain network configured to process transactions, execute smart contracts, and maintain consensus with respect to data stored on distributed ledger 108. Distributed ledger 108 may store transaction records, smart contract state, and other data associated with interactions between devices (e.g., between first device 102 and second device 104). In some examples, blockchain server 106 may execute a smart contract associated with tunnel 110 to manage asset locking, dispute resolution, and settlement operations.

Tunnel 110 provides an off-chain communication channel between first device 102 and second device 104 that enables the devices to exchange state updates without requiring each interaction to be recorded on distributed ledger 108, thereby reducing latency introduced by recording each state update to distributed ledger 108. In some examples, tunnel 110 is established in association with a smart contract deployed on blockchain server 106, such that the smart contract maintains a relationship with the off-chain interactions conducted via tunnel 110. For example, the smart contract may be configured to lock assets associated with first device 102 and second device 104, thereby initializing a shared state for tunnel 110.

During operation, first device 102 and second device 104 may exchange a sequence of state updates via tunnel 110. A state update may include state data representing a current state of an interaction and may be authenticated using cryptographic signatures generated by one or both of the devices (e.g., first device 102 and second device 104). In some examples, one of the devices (e.g., first device 102 or second device 104), may verify state updates generated by the other device prior to generating a corresponding cryptographic signature, thereby enforcing application-specific rules.

Accordingly, operating environment 100 enables efficient off-chain interaction between first device 102 and second device 104 via tunnel 110 while maintaining the ability to enforce correctness and resolve outcomes through on-chain mechanisms provided by blockchain server 106 and distributed ledger 108.

In some examples, the techniques described herein may be applied to low-latency micropayment interactions between participants using an off-chain communication channel in combination with on-chain escrow guarantees. In such examples, an initial on-chain transaction may be used to lock or escrow assets associated with one or both participating devices. The escrowed assets may define a maximum payable amount for a sequence of subsequent interactions conducted off-chain. For example, a first device may deposit a quantity of digital assets into a smart contract, thereby establishing an upper bound on value that can be transferred to a second device during the lifetime of an off-chain interaction.

Following establishment of the escrow, the participating devices (e.g., first device 102 and second device 104) may exchange a sequence of off-chain state updates representing incremental transfers of value. In some examples, a respective state update may correspond to a micropayment that adjusts a balance between the participants. The state updates may be cryptographically authenticated by both parties, for example through the use of digital signatures generated using private keys associated with the respective devices. In certain examples, the private keys used for signing may be ephemeral keys generated for the duration of a particular interaction or session, thereby enhancing security and reducing the risk associated with long-term key exposure.

A successive state update may supersede a prior state update and may reflect an updated allocation of the escrowed assets. Because the state updates are exchanged off-chain, a potentially large number of micropayment interactions may be performed without requiring corresponding on-chain transactions for each update. Instead, the state updates may be retained by the participants as cryptographically verifiable records of the evolving interaction state.

At an appropriate time, such as upon completion of the interaction or in response to a failure condition, one or more of the state updates may be selectively submitted to an on-chain smart contract. For example, the most recent co-signed state update may be submitted as proof of the final agreed-upon allocation of assets. Thus, the number of on-chain transactions to complete a sequence of micropayments may be reduced. In some examples, an initial escrow transaction and a final settlement transaction may be recorded on-chain in a cooperative scenario, regardless of the number of off-chain micropayment updates exchanged between the participants.

In adversarial scenarios, the smart contract may support a dispute resolution process in which either participant may submit a state update and associated cryptographic signatures within a bounded time window. For example, if one participant submits an outdated state that is more favorable to that participant, the counterparty may submit a more recent state update within a predefined dispute period. The smart contract or blockchain server enforcing the smart contract may then evaluate competing submissions and determine a most recent valid state based on cryptographic linkage, sequence information, or other validation criteria. This bounded dispute mechanism ensures that settlement can be completed with a limited number of on-chain transactions while preserving correctness and fairness.

In some examples, a third-party entity or device, referred to herein as a referee, may be introduced to assist in maintaining or facilitating off-chain state updates. The referee may correspond to a computing system that participates in the interaction by receiving, storing, or relaying state updates between the primary participants. For example, the referee may maintain a copy of the current state of the interaction and may assist in ensuring availability of state updates in situations where one of the primary participants becomes temporarily unavailable.

In certain examples, the referee may perform verification operations similar to those described for one of the participating devices. For instance, the referee may verify cryptographic signatures associated with state updates, confirm that state transitions comply with predefined interaction rules, and maintain an ordered record of state updates. In some examples, the referee may generate its own cryptographic attestations or signatures indicating validation of a state update, although such attestations may be optional and may not replace the requirement for signatures from the primary participants.

The referee model may provide additional robustness in scenarios involving intermittent connectivity, device constraints, or delegated interaction management. For example, a user may delegate management of off-chain interactions to a service provider acting as a referee, while still retaining control over final settlement through cryptographic authorization. In such cases, the referee may facilitate continuous interaction while the user device is offline, and the user may later verify and co-sign a final state prior to settlement.

In some examples, the referee may also participate in dispute resolution by providing previously observed state updates or by assisting in submission of state data to the on-chain smart contract. However, the system may be configured such that the referee does not need to be fully trusted, as correctness of the interaction may ultimately be enforced through cryptographic verification and on-chain validation mechanisms.

Accordingly, the combination of escrow-based pre-funding, off-chain co-signed state updates, selective on-chain submission, and bounded dispute resolution enables efficient, low-latency micropayment interactions while maintaining strong guarantees of correctness and enforceability. The addition of referee-based models further enhances flexibility and robustness by supporting delegated interaction management and improved availability without compromising the trust-minimized nature of the system.

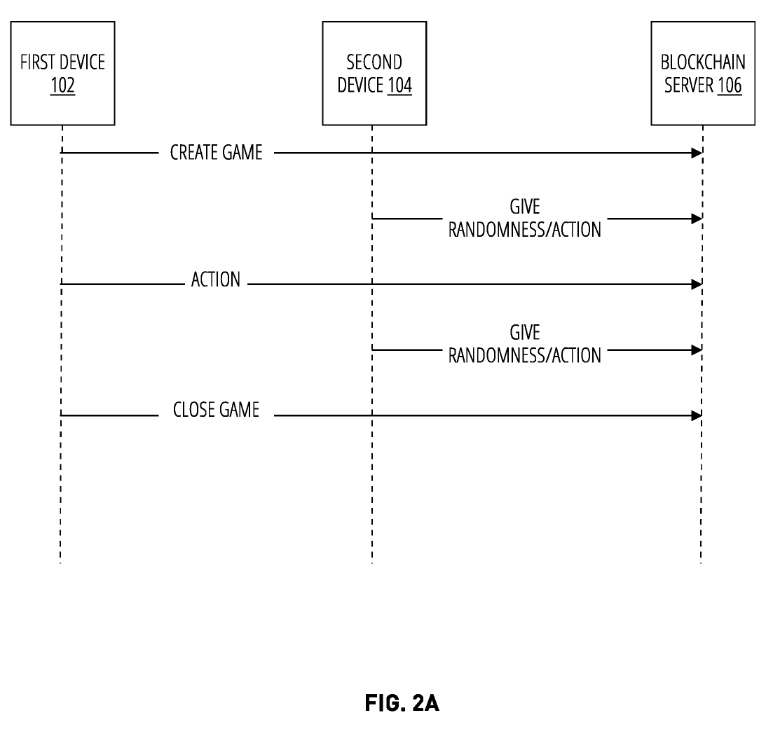

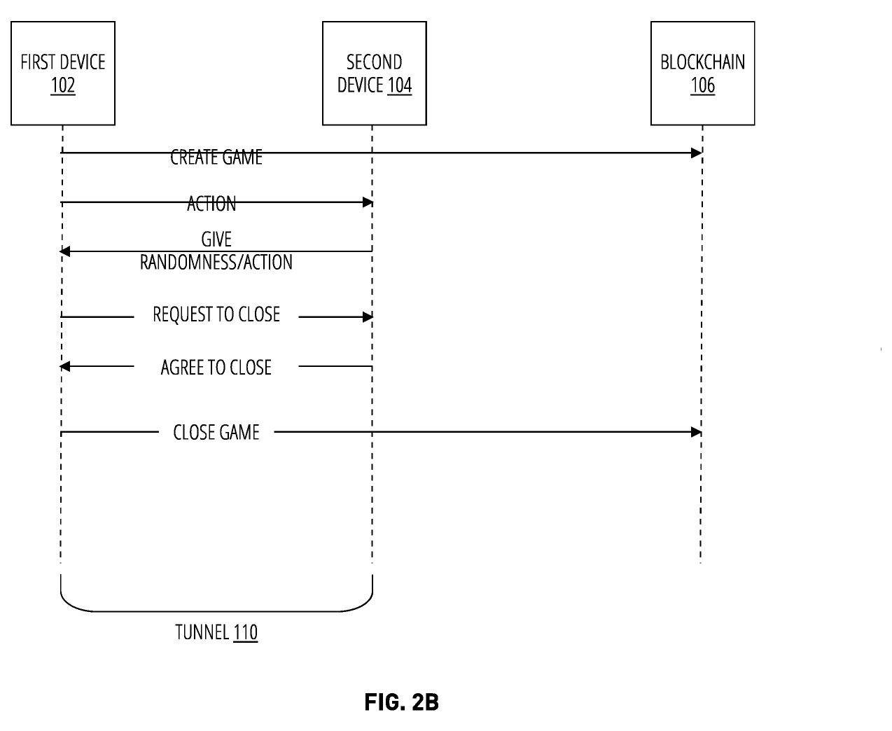

FIG. 2A illustrates an example interaction flow between first device 102, second device 104, and blockchain server 106 in a system in which interactions are processed using on-chain transactions. This could be, for example, a conventional system that does not include a tunnel to facilitate off-chain interactions.

In the example illustrated in FIG. 2A, first device 102 and second device 104 interact through blockchain server 106 by submitting transactions corresponding to application events. For instance, first device 102 may initiate an interaction by transmitting a request to blockchain server 106 to create an application instance, such as a game session. In response, blockchain server 106 may execute a corresponding smart contract and record the creation of the application instance on a distributed ledger (e.g., distributed ledger 108).

Following creation of the application instance, subsequent interactions between first device 102 and second device 104 are performed by submitting additional transactions to blockchain server 106. For example, first device 102 may transmit an action to blockchain server 106, which processes the action and updates the application state. Blockchain server 106 may then provide a response to second device 104, which may include updated state information or data used to determine a subsequent action. In some cases, blockchain server 106 may generate or provide data associated with the interaction, such as randomness or other state-dependent outputs, which are then communicated to one or both of the devices.

As illustrated, respective interaction steps, including actions and associated responses (e.g., “give randomness/action”), involves communication with blockchain server 106 and may result in one or more updates to the distributed ledger. This process may be repeated for multiple interaction steps, with each step requiring validation and recording by the blockchain network.

At the conclusion of the interaction, one or both of the devices may submit a request to blockchain server 106 to close the application instance, such as closing a game session. Blockchain server 106 may then execute corresponding logic to finalize the interaction and update the distributed ledger accordingly.

As illustrated in FIG. 2A, reliance on blockchain server 106 for processing each interaction step may introduce certain limitations. For example, each action and corresponding response may involve submission of a transaction, validation by the blockchain network, and recording on the distributed ledger, which can increase processing time and resource usage. As a result, applications involving frequent or time-sensitive interactions may experience reduced responsiveness. Additionally, repeated on-chain transactions may increase utilization of network resources and computational overhead associated with transaction validation and smart contract execution, affecting the efficiency of systems that involve sequences of rapid or continuous interactions between participating devices.

FIG. 2B illustrates an example interaction flow between first device 102, second device 104, and blockchain server 106 using an off-chain communication channel, referred to herein as tunnel 110.

In the example illustrated in FIG. 2B, first device 102 initially interacts with blockchain server 106 to establish an application instance, such as by creating a game or other interactive session. In some examples, establishing the application instance may include deploying or invoking a smart contract and locking assets associated with one or both of the devices on a distributed ledger. Following this initialization, first device 102 and second device 104 establish tunnel 110, which provides an off-chain communication channel for subsequent interactions.

Once tunnel 110 is established, first device 102 and second device 104 exchange interactions directly with one another via tunnel 110 without respective interactions being submitted to blockchain server 106. For example, first device 102 may generate an action and transmit corresponding state data to second device 104 through tunnel 110. Second device 104 may process the received state data, verify that the action complies with application rules, and generate a response, which may include an updated action and/or associated data such as randomness. In some examples, the interaction data exchanged between the devices may be authenticated using cryptographic signatures generated by the respective devices, thereby enabling each party to verify the integrity and authenticity of the exchanged state updates.

The exchange of actions and responses via tunnel 110 may be repeated for a sequence of interaction steps, forming a progression of state updates that represent a current state of the application. Because these interactions occur off-chain, the devices are able to perform updates without requiring validation and recording by blockchain server 106 for respective steps.

At a later stage, first device 102 (or, in some cases, second device 104) may initiate a request to close tunnel 110. In response, the devices may cooperatively finalize the interaction and submit one or more state updates, along with associated cryptographic data, to blockchain server 106. Blockchain server 106 may execute smart contract logic to verify the submitted data and record a final state on the distributed ledger.

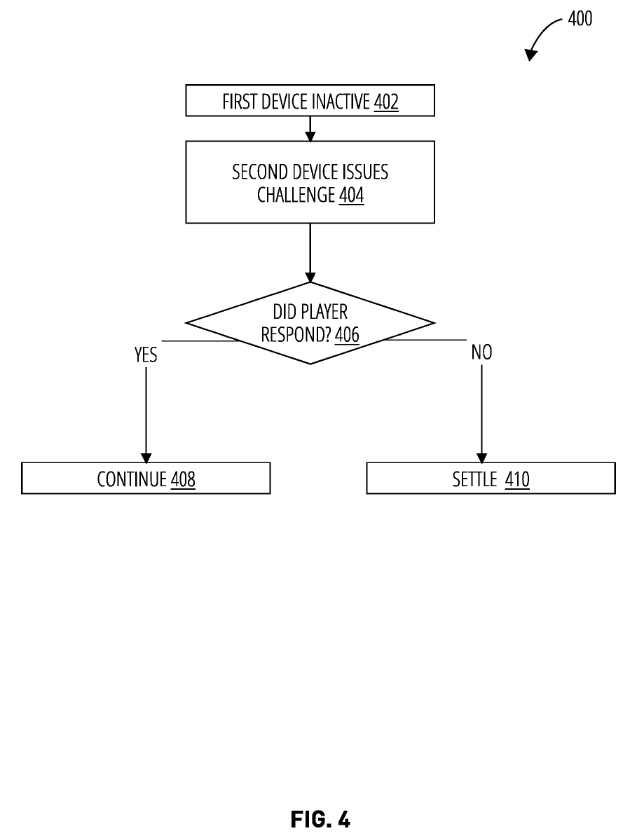

In some examples, if one of the devices does not cooperate in closing tunnel 110, a dispute resolution process may be initiated, as described with respect to FIG. 4. In such cases, a device may submit a state update and associated cryptographic data to blockchain server 106 to enable the smart contract to determine a valid outcome.

Accordingly, FIG. 2B illustrates an approach in which a sequence of interactions is conducted off-chain between first device 102 and second device 104 via tunnel 110, while maintaining the ability to rely on on-chain mechanisms for initialization, settlement, and resolution of exceptional conditions.

In some examples, the off-chain interaction framework described herein may be combined with zero-knowledge proof techniques to enable verification of state transitions without revealing underlying application data. For example, rather than submitting full state data to an on-chain smart contract, a participant may generate a zero-knowledge proof attesting that a particular state update was derived in accordance with predefined application logic and from a valid prior state. The proof may be generated using a zero-knowledge virtual machine or other proving system capable of producing succinct cryptographic proofs of correct execution.

In such examples, the blockchain server or smart contract may store or otherwise access a verification key associated with the zero-knowledge proof system. When a state update is submitted for settlement or dispute resolution, the submitting party may provide both the state update (or selected public inputs associated with the state) and a corresponding zero-knowledge proof. The smart contract may verify the proof using the verification key to confirm that the state transition is valid, without requiring access to the full underlying data or re-execution of the application logic on-chain. This approach may reduce on-chain computational overhead while preserving strong correctness guarantees.

Zero-knowledge proofs may be particularly useful in scenarios involving sensitive or proprietary application data, as they allow participants to demonstrate compliance with interaction rules without disclosing private information. For example, in a gaming context, a participant may prove that a sequence of moves was valid under game rules without revealing hidden game state, or in a financial context, a participant may prove correctness of a balance update without exposing transaction details. Additionally, the use of zero-knowledge proofs may enhance scalability by enabling compact representations of complex off-chain computations to be verified on-chain.

In some examples, a hybrid approach may be used in which cryptographic signatures are used during normal operation of the off-chain interaction, while zero-knowledge proofs are selectively used during dispute resolution or settlement. For instance, when both parties cooperate, a co-signed state update may be sufficient for settlement. However, in the event of a dispute or where additional assurance is desired, a zero-knowledge proof may be provided to validate the correctness of the state transition. This hybrid model allows the system to balance efficiency and security by minimizing the use of computationally intensive proof verification during routine operation while retaining the ability to enforce correctness in adversarial scenarios.

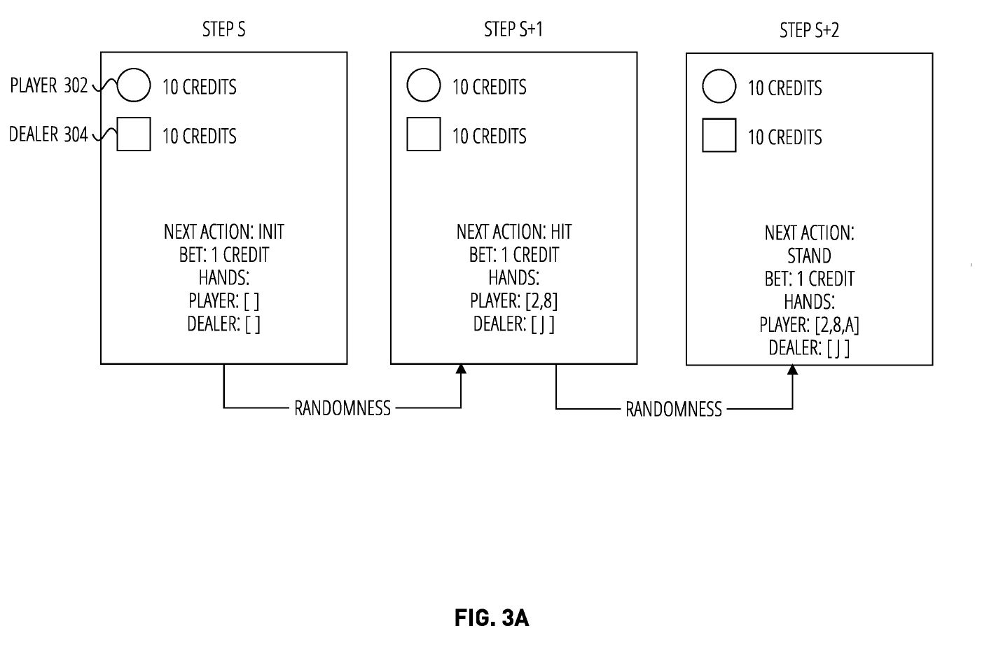

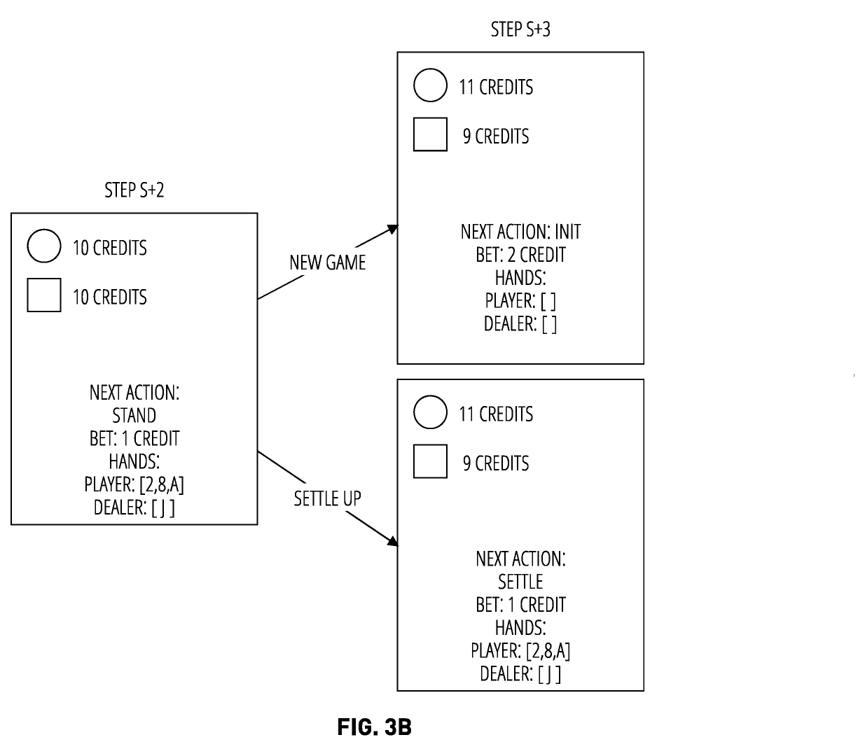

FIGS. 3A and 3B illustrate an example sequence of state updates associated with an interaction conducted via an off-chain communication channel (e.g., a tunnel), using a blackjack game as an illustrative use case. The blackjack game illustrated in FIGS. 3A and 3B is provided for purposes of explanation and is not intended to limit the scope of the disclosed techniques. The described state update mechanisms, cryptographic authentication processes, and off-chain interaction flows may be applied to a wide variety of applications involving stateful interactions between parties, including but not limited to payment systems, streaming services, and other interactive environments.

The scenario illustrated in FIGS. 3A and 3B represents an example implementation in which a blackjack game is conducted between a user (illustrated by Player 302) and a computerized dealer (illustrated by Dealer 304) over a networked environment. In this example, a first device (e.g., first device 102) may be operated by the user, while a second device (e.g., second device 104) may correspond to a server or automated system configured to perform the role of the dealer and enforce game logic. The user and the computerized dealer interact through a sequence of game actions, such as placing bets and requesting additional cards, with the dealer responding by validating actions, providing game outcomes, and supplying data such as card distributions. The interaction is conducted as a series of state updates exchanged between the devices (e.g., via tunnel 110), allowing the game to progress in a manner consistent with the rules of blackjack while leveraging the off-chain communication techniques described herein.

As shown in FIGS. 3A and 3B the interaction progresses through a sequence of states, denoted as step S, step S+1, step S+2, and step S+3. A respective state represents a respective state update that includes state data corresponding to the current status of the interaction. In the illustrated example, the state data includes information such as a balance associated with each participant (e.g., credits), a current action (e.g., “init” (e.g., initializing a game), “hit,” “stand,” or “settle”), a wager amount, and game-specific data such as card hands for a player and a dealer. In some examples, the credits may be various amounts of currency or cryptocurrency.

As shown in FIG. 3A, at step S, an initial state may be established, for example, by initializing a game session at the request of a user. The initialized game session may have a specified wager amount and initial balances for the participants. At step S, both players have an initial amount of credits with which to bet on respective hands of blackjack. In some examples, initializing the game may include establishing an off-chain communication channel (e.g., tunnel 110) between a device of the player or user and a device of the dealer.

In the transition from step S to step S+1, a randomness value may be used to determine one or more probabilistic outcomes associated with the interaction, such as the selection of a card to be dealt to the player in the blackjack game. In some examples, this randomness value is derived from cryptographic data associated with the interaction, for example by computing a hash or other deterministic function over a cryptographic signature generated in connection with the state at step S. Because the signature is generated based on authenticated state data and is not known prior to its creation, the resulting randomness value provides an unpredictable yet verifiable input for the subsequent state update. This allows both participants to independently derive and verify the same randomness value for step S+1, thereby supporting fair and consistent progression of the game without requiring reliance on an external randomness source or on-chain computation.

At step S+1, the state is updated in response to an action taken by one of the participants. For example, in response to receiving a first hand including a card with, for example, a point value of two and a card with a point value of eight. These card values may be randomly generated or selected using the randomness value derived from the step S state data. To proceed to step S+2, the player may select a “hit” action.

In response to selecting a “hit” action, an additional card is drawn by the dealer at random from the remaining cards in the deck. The updated state reflects the new game data, including updated hands and continuation of the wager. At step S+2, a subsequent action, such as a “stand” action, is processed, resulting in a further updated state that reflects the current configuration of the game.

In some examples, the states illustrated in FIG. 3A may correspond to a state update that is exchanged between the participants via the off-chain communication channel and authenticated using cryptographic operations. For example, a first participant (e.g., the player) may generate state data and a corresponding action, and a second participant (e.g., the dealer) may verify the state data and generate a corresponding cryptographic signature. In some examples, the state updates may be linked using cryptographic techniques, such as by including a cryptographic hash of a prior state update in a subsequent state update, thereby forming a verifiable sequence of states representing the progression of the interaction.

In some examples, the linking of states is achieved by incorporating, into a given state update, a cryptographic digest (e.g., a hash) of the preceding state update, along with associated cryptographic signatures (e.g., the digital signatures generated by one or both participating devices over the state data of a given state update). As a result, a modification to an earlier state may alter its digest (e.g., hash) and break the linkage with subsequent states, allowing detection of tampering or inconsistencies. This cryptographic chaining provides a mechanism for ensuring integrity of the sequence of state updates and allows participants or an on-chain smart contract to identify a most recent valid state among competing submissions. Accordingly, linking state updates in this manner is important for preserving an authoritative history of the interaction, preventing replay or stale state attacks, and enabling reliable resolution of the interaction in both cooperative and adversarial scenarios.

FIG. 3B illustrates a continuation of the interaction from step S+2 to a subsequent step S+3. As shown, after step S+2, the player can either initialize a new game or hand, or can settle up using their current credits. In one example, the player may select to initialize a new game. In this example, the player and dealer may continue with their current amounts of credits (e.g., based on their starting credits and the outcome of the previous hand). In some examples, the player can modify the parameters of the game by modifying the wager amount.

In another example, the player may select to settle up at step S+3. In this example, the interaction may enter a settlement phase in which one or both participants finalize the outcome of the current sequence of state updates. For example, the player may initiate a “settle” action based on the most recent agreed-upon state, which reflects the results of the preceding game actions and associated credit balances. In response, the participants may determine a final allocation of credits (or other assets) according to the game outcome, as represented in the state data at step S+3. In some examples, the parties may cooperatively agree on this final state and conclude the interaction off-chain. Alternatively, the finalized state at step S+3, along with its associated cryptographic signatures, may be submitted to an on-chain smart contract to record the outcome and distribute locked assets accordingly. This settlement process ensures that the results of the interaction are enforceable and that each participant receives the appropriate allocation based on the most recent valid state.

In some examples, the parties (e.g., the player and the dealer) cooperatively agree on the final state through a process of mutual validation and co-signing of the latest state update. One party (e.g., the player) generates a final state update at step S+3 that reflects the outcome of the interaction, including final balances and any settlement actions. This state update is transmitted to the counterparty (e.g., the dealer), which verifies that the state is consistent with prior agreed-upon updates and complies with the applicable rules of the interaction. Upon successful verification, the counterparty generates a corresponding cryptographic signature over the same state data. Once both parties have produced valid signatures over the final state, the state is considered mutually agreed upon. Because the state update includes or references prior state updates (e.g., via cryptographic linking), both parties can be confident that the final state reflects the full sequence of interactions (e.g., from step S to step S+3). This co-signed final state can then be used as an authoritative representation of the outcome, either for concluding the interaction off-chain or for submission to an on-chain smart contract for settlement. Upon completion of the interaction or, in some cases, in response to a failure condition, one or more of the state updates and associated cryptographic data may be submitted to a blockchain-based smart contract for verification and settlement.

Although FIGS. 3A and 3B illustrate a blackjack game for purposes of explanation, it should be understood that the described techniques are not limited to gaming applications. The disclosed techniques may be applied to a variety of other applications involving stateful interactions between parties. For instance, the off-chain communication channel (e.g., tunnel 110) may be used to facilitate incremental or streaming payments, where value is transferred in small amounts over time as a service is consumed. Similarly, disclosed techniques may be applied to streaming content delivery scenarios in which access to content is conditioned on ongoing interaction between a user and a service provider. Other examples include interactive multiplayer or single-player games with a remote server, collaborative applications involving shared state updates, and secure peer-to-peer data exchanges. In each of these scenarios, the use of cryptographically authenticated state updates and an off-chain interaction model enables efficient, low-latency operation while maintaining the ability to enforce outcomes through on-chain mechanisms when needed.

FIG. 4 illustrates an example method 400 for handling a failure condition that may arise during off-chain interactions between a first device and a second device in accordance with some aspects of the present disclosure. Method 400 can, for example, be used to handle a failure condition arising during an interaction between first device 102 and second device 104 via tunnel 110.

At block 402, method 400 may be initiated in response to detecting a failure condition associated with an off-chain interaction, such as when the first device (e.g., first device 102) becomes inactive. Inactivity may include, for example, a failure to respond within a predetermined period of time, a failure to provide a required cryptographic signature for a state update, or an interruption in communication over the off-chain communication channel.

At block 404, method 400 may include, in response to the detected inactivity, initiating by the second device (e.g., second device 104) a challenge procedure. The challenge may include transmitting a request for the first device to provide a response, such as submitting a valid state update, providing a required cryptographic signature, or otherwise demonstrating continued participation in the interaction. In some examples, the challenge may also include submission of a state update and associated cryptographic data to an on-chain smart contract (e.g., a smart contract managed by blockchain server 106), thereby initiating a dispute resolution process.

At block 406, method 400 can include determining (e.g., by second device 104 or blockchain server 106) whether the first device responds to the challenge. A response may include, for example, providing a valid and more recent state update that is cryptographically authenticated, or supplying a required signature for a pending state update. If the first device responds within an allowed time period (e.g., ten minutes, twenty minutes, one hour, etc.), the interaction may continue off-chain via tunnel 110, as indicated at block 408. In such cases, the newly provided state update may supersede any previously submitted state, and the off-chain interaction may proceed using the updated state.

The time period for responding to a challenge may be determined based on one or more predefined parameters associated with the off-chain communication channel (e.g., tunnel 110) or the corresponding on-chain smart contract managed by blockchain server 106. In some examples, the time period, sometimes referred to as a dispute period, may be specified at the time the interaction is initialized and may be stored on-chain to ensure consistent enforcement. The duration of the dispute period may be selected based on factors such as expected network latency, typical response times of participating devices, and desired trade-offs between responsiveness and fairness. For example, a longer time period may provide additional opportunity for a temporarily offline participant to respond, while a shorter time period may enable faster settlement of the interaction. In certain examples, the time period may be dynamically adjusted or configurable based on application requirements or participant preferences. Regardless of how it is determined, the time period defines a window during which a challenged party may submit a valid response, such as a more recent state update or required cryptographic signature, before the interaction proceeds to settlement.

If, however, the first device does not respond to the challenge within the allowed time period, method 400 may include proceeding to settlement, as indicated at block 410. In some examples, settlement may include submitting one or more state updates and associated cryptographic signatures to a smart contract executed by a blockchain server. The smart contract may verify the submitted data, determine a most recent valid state of the interaction, and finalize an outcome based on that state. For example, the smart contract may distribute assets between the participants according to balances specified in the verified state.

Accordingly, FIG. 4 illustrates a mechanism by which off-chain interactions may be safely managed in the presence of failure conditions, enabling continuation of the interaction when possible and ensuring enforceable settlement through on-chain mechanisms when cooperation between participants cannot be achieved.

In certain scenarios, a participant may attempt to submit a state update that does not reflect the most recent valid state of the interaction, for example by submitting an earlier state that yields a more favorable outcome for that participant. Such behavior may occur during settlement or in response to a dispute, where a participant seeks to rely on outdated or selectively chosen state data. To address this, the present technology uses verification of submitted state updates based on their associated cryptographic data and their position within the sequence of state updates exchanged between the participants.

For example, a state update includes cryptographic signatures from the participating devices and is linked to prior state updates through cryptographic operations, such as inclusion of a hash of a preceding state. As a result, when a participant submits a state update to an on-chain smart contract, the smart contract can verify the authenticity of the submitted state and determine its relative position within the sequence of states. If another participant possesses a more recent state update that supersedes the submitted state, that participant may submit the more recent state update along with corresponding cryptographic signatures within a defined dispute period.

The smart contract or blockchain server 106 may then compare the competing state updates and identify a most recent valid state based on criteria such as sequence ordering, timestamps, or cryptographic linkage. Because a valid state update is authenticated by both participants and linked to prior states, a participant cannot successfully substitute an outdated state without risk of being overridden by a newer, properly authenticated state. Thus, attempts to cheat by submitting stale or manipulated state data are mitigated, as the system favors the most recent mutually agreed-upon state.

If a participant fails to provide a newer valid state within the allowed response period, the smart contract may proceed to finalize the interaction based on the submitted state. Conversely, if a valid newer state is provided, the smart contract may use that state to determine the final outcome, including allocation of assets. This dispute resolution process ensures that even in adversarial scenarios, the interaction is resolved according to the correct sequence of state updates, preserving fairness and integrity of the system.

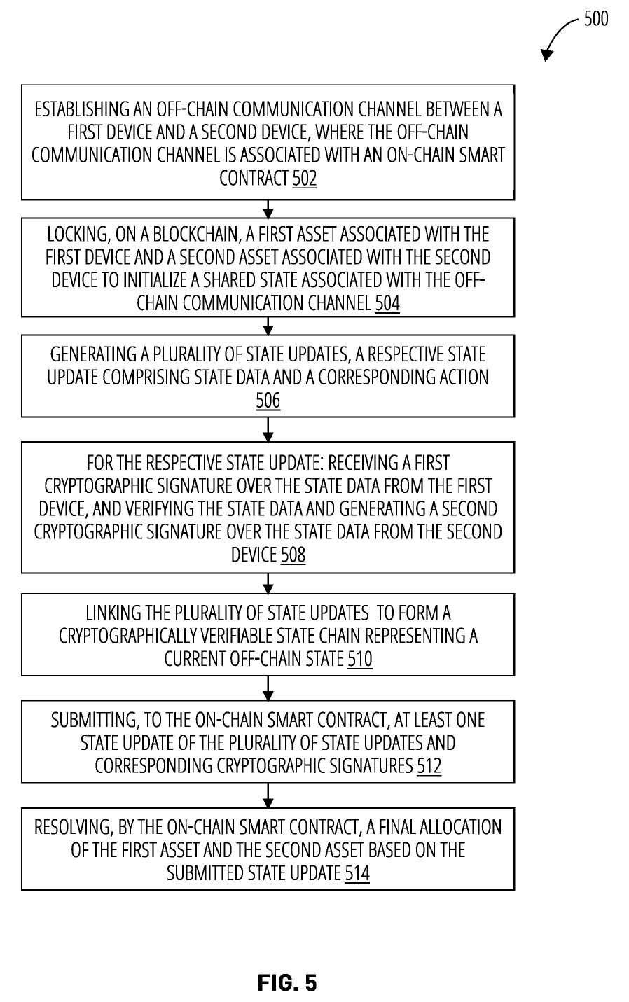

FIG. 5 illustrates an example method 500 for facilitating off-chain interactions between a first device and a second device using an off-chain communication channel associated with an on-chain smart contract.

At block 502, method 500 can include establishing an off-chain communication channel (e.g., tunnel 110) between a first device (e.g., first device 102) and a second device (e.g., second device 104). The tunnel (i.e., off-chain communication channel) may be established through an initialization procedure performed by first device 102, second device 104, and/or blockchain server 106 in coordination with an on-chain smart contract. In some examples, one of the participating devices, such as the first device, initiates creation of the tunnel by invoking the smart contract on the blockchain and specifying parameters associated with the interaction. These parameters may include identifiers of the participating devices, corresponding cryptographic public keys, an initial allocation of assets, and operational parameters such as a dispute period. In response, the smart contract (e.g., via blockchain server 106) may instantiate a tunnel instance and prepare to manage associated state and assets.

In some examples, as part of establishing the tunnel, at block 504, method 500 can include depositing or locking, by a participating device or participating devices, respective assets on the blockchain via the smart contract. The locked assets define an initial shared state associated with the tunnel and may serve as the basis for subsequent state updates exchanged off-chain. The smart contract may maintain a record of the deposited assets, participant identities, and associated public keys, thereby enabling later verification of cryptographic signatures and enforcement of settlement conditions. In some examples, the assets are locked by invoking the smart contract, which maintains custody of the assets until the interaction is completed or otherwise resolved.

Following on-chain initialization, the first device and the second device establish a direct or indirect communication link to exchange data off-chain. For example, the devices may communicate over a peer-to-peer network connection, an application-layer messaging protocol, or another communication interface. The devices may also exchange initialization data, such as confirmation of the tunnel parameters and cryptographic information, so that both parties are synchronized with respect to the starting state.

Once the tunnel is established, the devices may begin exchanging state updates off-chain, as described herein. The combination of on-chain initialization (including asset locking and parameter definition) and off-chain communication setup enables the tunnel to support efficient interaction while preserving the ability to enforce correctness and resolve disputes using the associated smart contract.

At block 506, method 500 can include generating off-chain, by the first device and/or the second device, a plurality of state updates that represent interactions between the first device and the second device. A state update may include state data, such as balances, application-specific data, and an indication of an action to be performed. The state updates may be generated sequentially as the interaction between the devices progresses.

At block 508, method 500 can include authenticating, by the first device and/or the second device, a respective state update using cryptographic signatures. For example, the first device may generate a first cryptographic signature by signing the state data using a private key associated with the first device. The signed state data is transmitted to the second device, which verifies the first cryptographic signature using a corresponding public key. Upon successful verification and validation of the state data against applicable interaction rules, the second device may generate a second cryptographic signature over the same state data. In some examples, the state data signed by one or both devices may include a cryptographic digest of a prior state update, thereby linking the state updates together. The presence of both signatures provides mutual authentication and establishes that both devices have agreed to the state update.

At block 510, method 500 can include linking, by the first device, the second device, and/or the blockchain server, the plurality of state updates to form a cryptographically verifiable state chain representing a current off-chain state. In some examples, a respective state update includes a hash or other cryptographic reference to a preceding state update, such that any modification to a prior state invalidates subsequent state updates. The cryptographic signatures associated with each state update further enable verification that the sequence of states was agreed upon by both participants.

At block 512, method 500 can include submitting, by the blockchain server, at least one state update of the plurality of state updates, along with corresponding cryptographic signatures, to the on-chain smart contract. This submission may occur, for example, in response to completion of the interaction, initiation of a settlement, or detection of a failure condition. The submitted state update may represent a most recent agreed-upon state between the participants.

At block 514, method 500 can include resolving, by the blockchain server based on the smart contract, a final allocation of the first asset and the second asset based on the submitted state update. In some examples, the smart contract verifies the cryptographic signatures associated with the submitted state update and confirms its validity within the state chain. If multiple state updates are submitted, the smart contract may determine a most recent valid state based on the cryptographic linkage and associated signatures. Based on the verified state, the smart contract may distribute the locked assets to the respective devices in accordance with the state data.

Accordingly, the method 500 allows participants to conduct a sequence of interactions off-chain using cryptographically authenticated state updates, while preserving the ability to enforce outcomes and resolve disputes through on-chain verification and settlement.

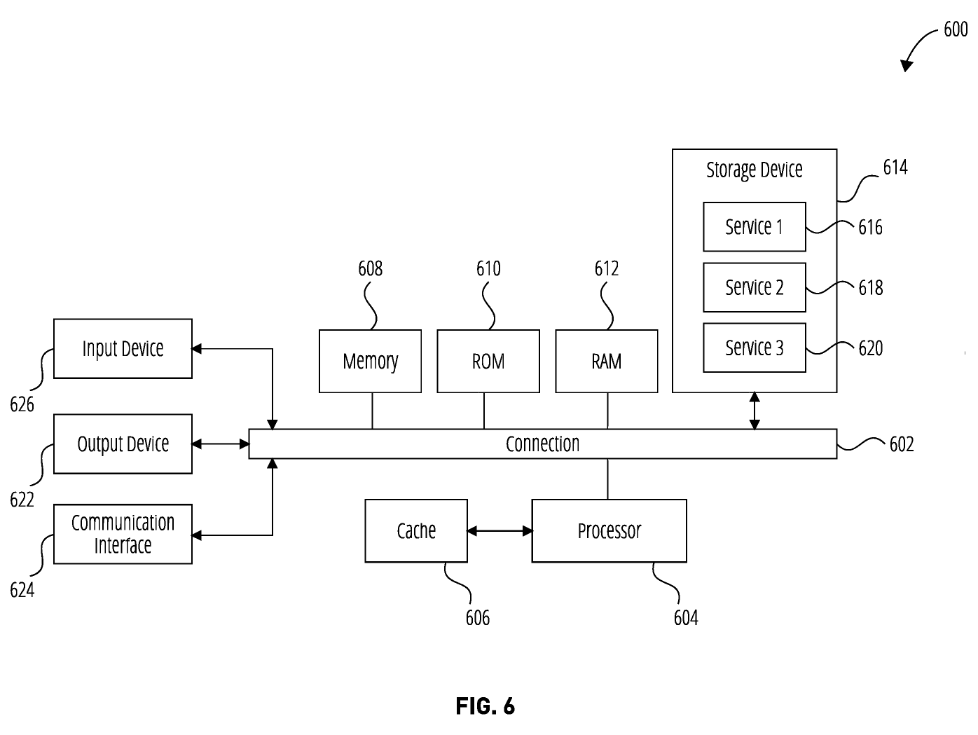

FIG. 6 shows an example of a computing system 600, which can be for example any computing device making up the account service, or any component thereof in which the components of the system are in communication with each other using connection 602. Connection 602 can be a physical connection via a bus, or a direct connection into processor 604, such as in a chipset architecture. Connection 602 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 600 includes at least one processing unit (CPU or processor) 604 and connection 602 that couples various system components including system memory 608, such as read-only memory (ROM) 610 and random access memory (RAM) 612 to processor 604. Computing system 600 can include a cache of high-speed memory 606 connected directly with, in close proximity to, or integrated as part of processor 604.

Processor 604 can include any general purpose processor and a hardware service or software service, such as services 616, 618, and 620 stored in storage device 614, configured to control processor 604 as well as a special-purpose processor where software instructions are incorporated into the actual processor design. Processor 604 may essentially be a completely self-contained computing system, containing multiple cores or processors, a bus, memory controller, cache, etc. A multi-core processor may be symmetric or asymmetric.

To enable user interaction, computing system 600 includes an input device 626, which can represent any number of input mechanisms, such as a microphone for speech, a touch-sensitive screen for gesture or graphical input, keyboard, mouse, motion input, speech, etc. Computing system 600 can also include output device 622, which can be one or more of a number of output mechanisms known to those of skill in the art. In some instances, multimodal systems can enable a user to provide multiple types of input/output to communicate with computing system 600. Computing system 600 can include communication interface 624, which can generally govern and manage the user input and system output. There is no restriction on operating on any particular hardware arrangement, and therefore the basic features here may easily be substituted for improved hardware or firmware arrangements as they are developed.

Storage device 614 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 614 can include software services, servers, services, etc., that when the code that defines such software is executed by the processor 604, it causes the system to perform a function. In some embodiments, a hardware service that performs a particular function can include the software component stored in a computer-readable medium in connection with the necessary hardware components, such as processor 604, connection 602, output device 622, etc., to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Some aspects of the present technology include:
Aspect 1: A computer-implemented method comprising: locking, on a blockchain by a blockchain server, a first asset associated with a first device and a second asset associated with a second device to initialize a shared state associated with an off-chain communication channel between the first device and the second device, wherein the off-chain communication channel is associated with an on-chain smart contract governing interactions between the first device and the second device; receiving, by the blockchain server from at least one of the first device or the second device, at least one state update selected from a plurality of off-chain state updates representing interactions between the first device and the second device over the off-chain communication channel, wherein the plurality of off-chain state updates are cryptographically authenticated by the first device and the second device; and submitting, by the blockchain server to the on-chain smart contract, the at least one state update and corresponding cryptographic signatures, wherein the on-chain smart contract resolves a final allocation of the first asset and the second asset based on the at least one state update.
Aspect 2: The computer-implemented method of Aspect 1, further comprising: verifying, by the blockchain server, state data received in the at least one state update by validating a first cryptographic signature used to sign the state data by using a public key associated with the first device; and verifying, by the blockchain server, the state data by validating a second cryptographic signature used to sign the state data by using a public key associated with the second device.
Aspect 3: The computer-implemented method of any of Aspects 1-2, wherein the first cryptographic signature and the second cryptographic signature are generated using different cryptographic signature schemes.
Aspect 4: The computer-implemented method of any of Aspects 1-3, wherein the plurality of off-chain state updates comprise a cryptographically verifiable state chain representing a current off-chain state of the interaction between the first device and the second device.
Aspect 5: The computer-implemented method of any of Aspects 1-4, wherein submitting the at least one state update to the on-chain smart contract is performed in response to detecting a failure condition comprising a failure of at least one of the first device or the second device to provide a required cryptographic signature.
Aspect 6: The computer-implemented method of any of Aspects 1-5, wherein submitting the at least one state update to the on-chain smart contract is performed in response to detecting a dispute associated with a state update.
Aspect 7: The computer-implemented method of any of Aspects 1-6, further comprising: submitting, by the blockchain server to the on-chain smart contract, a subsequent state update that supersedes the at least one state update to invalidate a stale state.
Aspect 8: The computer-implemented method of any of Aspects 1-7, wherein the on-chain smart contract resolves the final allocation based on a most recent valid state update among multiple submitted state updates.
Aspect 9: The computer-implemented method of any of Aspects 1-8, wherein submitting the at least one state update further comprises submitting a zero-knowledge proof attesting to validity of the state update.
Aspect 10: The computer-implemented method of any of Aspects 1-9, wherein resolving the final allocation comprises verifying the zero-knowledge proof using a verification key stored on-chain.
Aspect 11: The computer-implemented method of any of Aspects 1-10, wherein the first asset and the second asset are locked as an escrow that defines a maximum transferable amount between the first device and the second device during the off-chain communication.
Aspect 12: The computer-implemented method of any of Aspects 1-11, wherein the plurality of off-chain state updates represent a sequence of incremental transfers of value between the first device and the second device.
Aspect 13: The computer-implemented method of any of Aspects 1-12, wherein a successive state update supersedes a prior state update by updating an allocation of the escrowed assets.
Aspect 14: The computer-implemented method of any of Aspects 1-13, wherein the sequence of incremental transfers comprises micropayments performed without corresponding on-chain transactions for each transfer.
Aspect 15: The computer-implemented method of any of Aspects 1-14, wherein at least one cryptographic signature of the corresponding cryptographic signatures is generated using an ephemeral private key associated with a session of the off-chain communication channel.
Aspect 16: The computer-implemented method of any of Aspects 1-15, wherein the ephemeral private key is generated for a duration of the off-chain communication channel and is not reused across multiple sessions.
Aspect 17: The computer-implemented method of any of Aspects 1-16, wherein the on-chain smart contract enforces a dispute period during which competing state updates may be submitted.
Aspect 18: The computer-implemented method of any of Aspects 1-17, wherein the dispute period defines a bounded time window within which a subsequent state update may be submitted to supersede the at least one state update.
Aspect 19: The computer-implemented method of any of Aspects 1-18, wherein at least one cryptographic signature of the corresponding cryptographic signatures is generated using an ephemeral private key associated with a session of the off-chain communication channel.
Aspect 20: The computer-implemented method of any of Aspects 1-19, wherein the ephemeral private key is generated for a duration of the session and is not reused across multiple sessions.
Aspect 21: The computer-implemented method of any of Aspects 1-20, wherein the on-chain smart contract enforces a dispute period defining a bounded time window within which a subsequent state update may be received and submitted to supersede a stale state update.
Aspect 22: The computer-implemented method of any of Aspects 1-21, wherein the first cryptographic signature is generated using an ED25519 signature scheme and the second cryptographic signature is generated using a BLS signature scheme.
Aspect 23: The computer-implemented method of any of Aspects 1-22, wherein the plurality of off-chain state updates correspond to a game interaction in which the second device validates an action represented by a respective state update before generation of the BLS signature, and wherein a randomness value derived from the BLS signature is used to determine a subsequent game outcome represented by a subsequent state update.
Aspect 24: A non-transitory computer-readable medium having stored thereon instructions that, when executed by at least one processor, cause the at least one processor to perform operations according to any of Aspects 1-23.
Aspect 25: A computing system for performing a function, comprising one or more means for performing operations according to any of Aspects 1-23.
Aspect 26. A computer-implemented method comprising: establishing, by a first device, an off-chain communication channel with a second device in association with an on-chain smart contract that locks a first asset associated with the first device and a second asset associated with the second device to define a shared state for the off-chain communication channel; generating, by the first device, a state update representing an interaction over the off-chain communication channel; signing, by the first device using an ephemeral private key associated with a session of the off-chain communication channel, state data of the state update; transmitting, by the first device, the state update to the second device for validation of the interaction and generation of a counterparty cryptographic signature over the state data; generating, by the first device, a subsequent state update based on a randomness value derived from the counterparty cryptographic signature and a cryptographic link to the state update; and submitting, by the first device in response to completion of the interaction or a dispute, the subsequent state update and corresponding cryptographic signatures to the on-chain smart contract to resolve allocation of the first asset and the second asset.
Aspect 27: The computer-implemented method of Aspect 26, wherein the interaction comprises a game interaction and the second device corresponds to a dealer server configured to validate a requested game action before generating the counterparty cryptographic signature.
Aspect 28: The computer-implemented method of any of Aspects 26-27, wherein the on-chain smart contract enforces a dispute period defining a bounded time window within which a more recent state update is submitted to supersede a stale state update.
Aspect 29: The computer-implemented method of any of Aspects 26-28, wherein the state data is signed by the first device using an ED25519 signature scheme and the counterparty cryptographic signature is generated using a BLS signature scheme.
Aspect 30: A non-transitory computer-readable medium having stored thereon instructions that, when executed by at least one processor, cause the at least one processor to perform operations according to any of Aspects 26-29.
Aspect 31: A computing system for performing a function, comprising one or more means for performing operations according to any of Aspects 26-29.

What is claimed is:

1. A computer-implemented method comprising:
locking, on a blockchain by a blockchain server, a first asset associated with a first device and a second asset associated with a second device to initialize a shared state associated with an off-chain communication channel between the first device and the second device, wherein the off-chain communication channel is associated with an on-chain smart contract governing interactions between the first device and the second device;
receiving, by the blockchain server from at least one of the first device or the second device, at least one state update selected from a plurality of off-chain state updates representing interactions between the first device and the second device over the off-chain communication channel, wherein the plurality of off-chain state updates are cryptographically authenticated by the first device and the second device; and
submitting, by the blockchain server to the on-chain smart contract, the at least one state update and corresponding cryptographic signatures, wherein the on-chain smart contract resolves a final allocation of the first asset and the second asset based on the at least one state update.

2. The computer-implemented method of claim 1, further comprising:
verifying, by the blockchain server, state data received in the at least one state update by validating a first cryptographic signature used to sign the state data by using a public key associated with the first device; and
verifying, by the blockchain server, the state data by validating a second cryptographic signature used to sign the state data by using a public key associated with the second device.

3. The computer-implemented method of claim 2, wherein the first cryptographic signature and the second cryptographic signature are generated using different cryptographic signature schemes.

4. The computer-implemented method of claim 1, wherein the plurality of off-chain state updates comprise a cryptographically verifiable state chain representing a current off-chain state of the interaction between the first device and the second device.

5. The computer-implemented method of claim 1, wherein submitting the at least one state update to the on-chain smart contract is performed in response to detecting a failure condition comprising a failure of at least one of the first device or the second device to provide a required cryptographic signature.

6. The computer-implemented method of claim 1, wherein submitting the at least one state update to the on-chain smart contract is performed in response to detecting a dispute associated with a state update.

7. The computer-implemented method of claim 1, further comprising:
submitting, by the blockchain server to the on-chain smart contract, a subsequent state update that supersedes the at least one state update to invalidate a stale state.

8. The computer-implemented method of claim 7, wherein the on-chain smart contract resolves the final allocation based on a most recent valid state update among multiple submitted state updates.

9. The computer-implemented method of claim 1, wherein submitting the at least one state update further comprises submitting a zero-knowledge proof attesting to validity of the state update.

10. The computer-implemented method of claim 9, wherein resolving the final allocation comprises verifying the zero-knowledge proof using a verification key stored on-chain.

11. A computing system comprising:
at least one processor; and
a memory storing instructions that, when executed by the processor, configure the computing system to:
lock, on a blockchain, a first asset associated with a first device and a second asset associated with a second device to initialize a shared state associated with an off-chain communication channel between the first device and the second device, wherein the off-chain communication channel is associated with an on-chain smart contract governing interactions between the first device and the second device;
receive, from at least one of the first device or the second device, at least one state update selected from a plurality of off-chain state updates representing interactions between the first device and the second device over the off-chain communication channel, wherein the plurality of off-chain state updates are cryptographically authenticated by the first device and the second device; and
submit, to the on-chain smart contract, the at least one state update and corresponding cryptographic signatures, wherein the on-chain smart contract resolves a final allocation of the first asset and the second asset based on the at least one state update.

12. The computing system of claim 11, wherein the first asset and the second asset are locked as an escrow that defines a maximum transferable amount between the first device and the second device during the off-chain communication.

13. The computing system of claim 12, wherein the plurality of off-chain state updates represent a sequence of incremental transfers of value between the first device and the second device.

14. The computing system of claim 13, wherein a successive state update supersedes a prior state update by updating an allocation of the escrowed assets.

15. The computing system of claim 13, wherein the sequence of incremental transfers comprises micropayments performed without corresponding on-chain transactions for each transfer.

16. A non-transitory computer-readable storage medium comprising instructions stored thereon that when executed by at least one processor, cause the at least one processor to:
lock, on a blockchain, a first asset associated with a first device and a second asset associated with a second device to initialize a shared state associated with an off-chain communication channel between the first device and the second device, wherein the off-chain communication channel is associated with an on-chain smart contract governing interactions between the first device and the second device;
receive, from at least one of the first device or the second device, at least one state update selected from a plurality of off-chain state updates representing interactions between the first device and the second device over the off-chain communication channel, wherein the plurality of off-chain state updates are cryptographically authenticated by the first device and the second device; and
submit, to the on-chain smart contract, the at least one state update and corresponding cryptographic signatures, wherein the on-chain smart contract resolves a final allocation of the first asset and the second asset based on the at least one state update.

17. The non-transitory computer-readable storage medium of claim 16, wherein at least one cryptographic signature of the corresponding cryptographic signatures is generated using an ephemeral private key associated with a session of the off-chain communication channel.

18. The non-transitory computer-readable storage medium of claim 17, wherein the ephemeral private key is generated for a duration of the off-chain communication channel and is not reused across multiple sessions.

19. The non-transitory computer-readable storage medium of claim 16, wherein the on-chain smart contract enforces a dispute period during which competing state updates may be submitted.

20. The non-transitory computer-readable storage medium of claim 19, wherein the dispute period defines a bounded time window within which a subsequent state update may be submitted to supersede the at least one state update.
